(19) United States
(12) Patent Application Publication
(10) Pub. No.: US 2011/0122621 A1
(43) Pub. Date: May 26, 2011

(54) LIGHTING DEVICE WITH SENSOR

(76) Inventor: KAIPO CHEN, Taoyuan Hsien (TW)

(21) Appl. No.: 12/625,544

(22) Filed: Nov. 24, 2009

(51) Int. Cl. F21S 4/00

(52) U.S. Cl. 362/249.02

(57) ABSTRACT

The lighting device contains an upper casing, a circuit board, a sensor assembly, a lower casing, and power adaptors. A number of light emitting diodes (LEDs) are configured on the circuit board. The upper and lower casings are joined to house the circuit board inside. The power adaptors are configured at two ends of assembled upper and lower casings and the circuit board. The sensor assembly contains a cylindrical casing threaded in a ring. The sensor assembly is then rotatably housed in a spherical concave on the circuit board. The sensor assembly's rotational angle could be easily adjusted to aim to cover any desired area. The power adaptors allow the lighting device to be installed to conventional sockets for fluorescent light tubes.

### (A) TECHNICAL FIELD OF THE INVENTION

The present invention generally relates to lighting devices, and especially relates to a lighting device integrating a sensor assembly whose direction could be easily and conveniently adjusted.

### (B) DESCRIPTION OF THE PRIOR ART

Various sensor devices have been widely applied in daily lives. One common application is to integrate a lighting device with a sensor so as to control the lighting device's turning on and off.

Regardless its type and quality, a sensor usually has a specific sensing direction and a specific coverage. As such, the sensor has to be manually adjusted to aim at the desired direction and coverage or some automatic adjustment means is required before the sensor is put to use. Therefore, the sensor is usually mounted on some pivot and could be adjusted by some lever. However, with these additional means, the sensor becomes bulky and therefore cannot be integrated with lighting devices of smaller dimensions such as fluorescent light tubes. The lighting devices as such cannot attain the energy saving capability provided by the sensors.

### SUMMARY OF THE INVENTION

Accordingly, a novel lighting device with an integrated sensor assembly is provided herein to obviate the foregoing shortcomings of the prior arts.

The lighting device contains an upper casing, a circuit board, a sensor assembly, a lower casing, and power adaptors. A number of light emitting diodes (LEDs) are configured on the circuit board. The upper and lower casings are joined to house the circuit board inside. The power adaptors are configured at two ends of assembled upper and lower casings and the circuit board. The sensor assembly contains a cylindrical casing threaded in a ring. The sensor assembly is then rotatably housed in a spherical concave on the circuit board. The sensor assembly's rotational angle could be easily adjusted to aim to cover any desired area. In addition, as no levers or pivots are used, the sensor assembly could have a smaller dimension and could be more flexibly applied to various lighting devices. The power adaptors allow the lighting device to be installed to conventional sockets for fluorescent light tubes.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a lighting device according to an embodiment of the present invention.

FIG. 2 is a perspective break-down diagram showing the various components of the lighting device of FIG. 1.

FIG. 3 is an enlarged schematic diagram showing a sensor assembly of the lighting device of FIG. 1.

FIG. 4 is a perspective diagram showing a lighting device according to another embodiment of the present invention.

FIG. 5 is a perspective diagram showing the lighting device of FIG. 4 with a cover to the sensor assembly removed.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

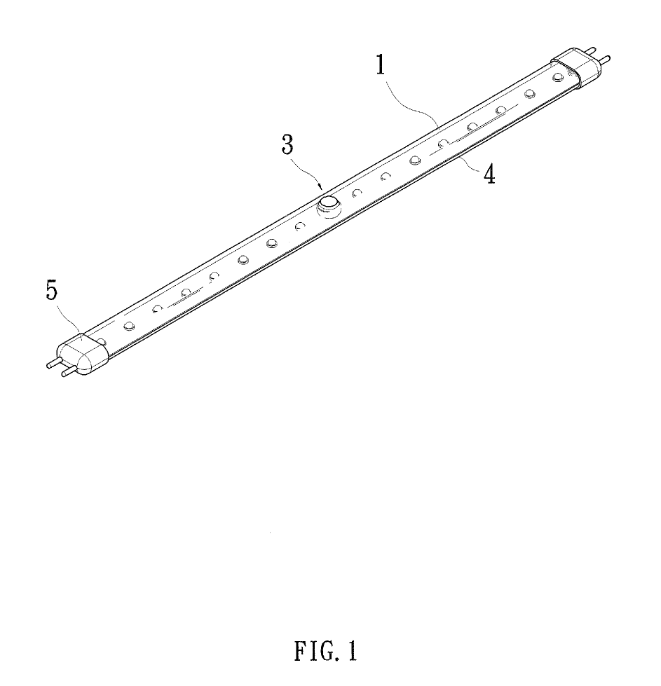

As illustrated in FIGS. 1 to 3, a lighting device in accordance with an embodiment of the present invention mainly contains an upper casing 1, a circuit board 2, a sensor assembly 3, a lower casing 4, and power adaptors 5.

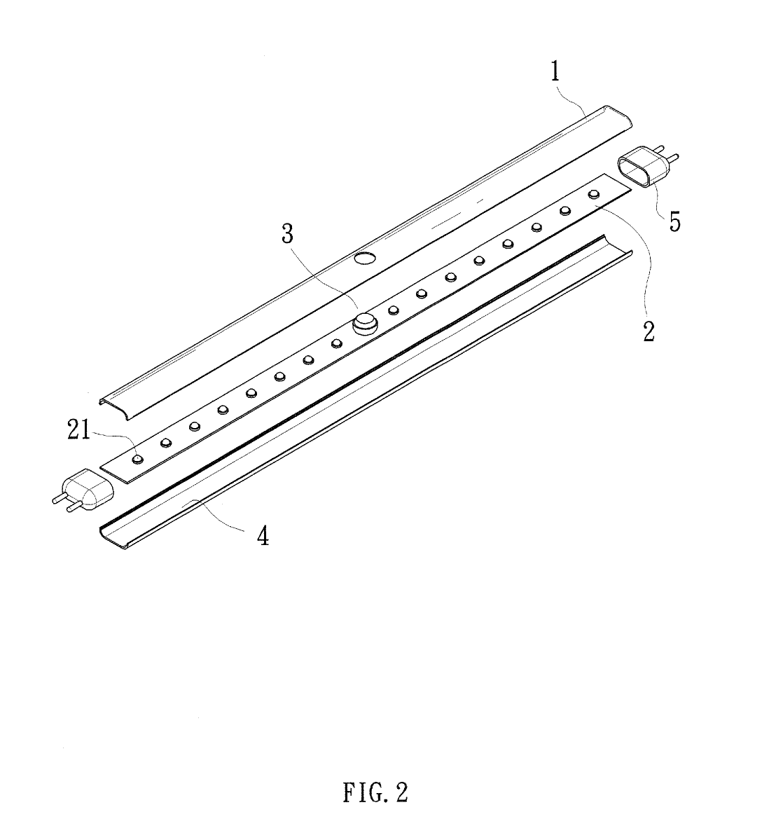

As exhibited in FIGS. 1 and 2, a number of light emitting diodes (LEDs) 21 are configured on a major side of the circuit board 2. The upper and lower casings 1 and 4 are joined together to form a space so that the circuit board 2 is housed inside. Two ends of the upper and lower casings 1 and 4, along with two ends of the circuit board 2, are together embedded in the power adaptors 5, respectively.

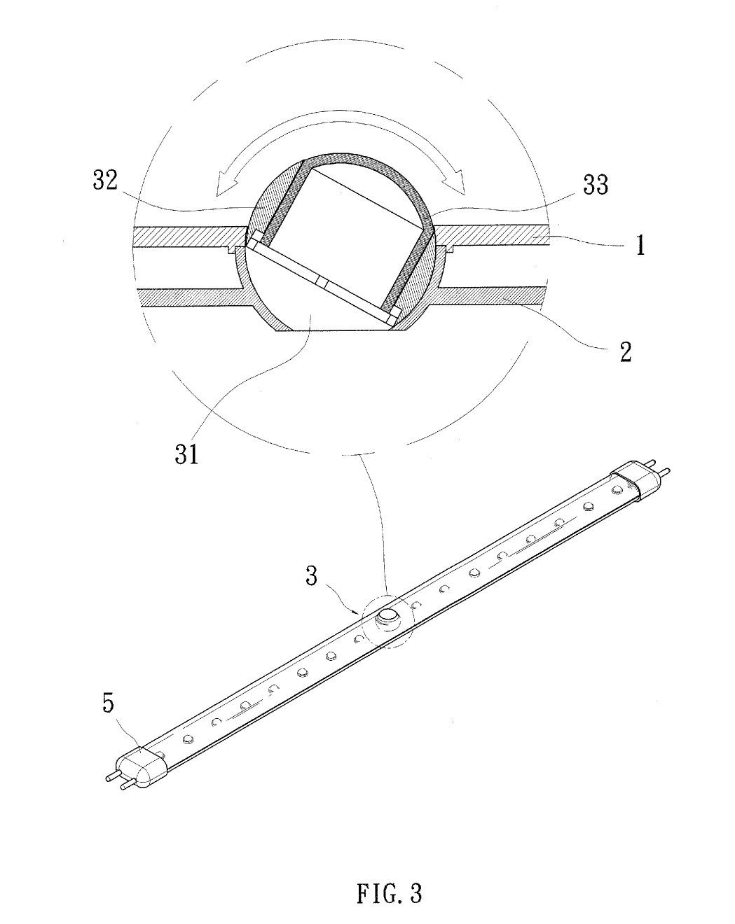

Also on the major side of the circuit board 2, the sensor assembly 3 is configured between two adjacent LEDs 21. The sensor assembly 3 contains, as shown in FIG. 3, a cylindrical casing 33 with a spherical top end and a ring 32. The cylindrical casing 33 is threaded through the ring 32, jointly constituting a substantially spherical shape. The sensor assembly 3 is then rotatably housed in a spherical concave 31 on the top side of the circuit board 2. The power adaptors 5 have terminals that could be fit in conventional sockets for fluorescent light tubes.

A sensor (not shown) housed inside the sensor assembly 3 could control the turning on and off of the lighting device. More significantly, the sensor assembly 3 (and therefore the sensor inside) could be easily turned to point to a desired coverage area. When a person or some object has entered the coverage area, the sensor inside the sensor assembly would detect the object and turn on the LEDs 21 of the lighting device. When the object leaves the coverage area, the sensor could turn off the LEDs 21 so as to save energy consumption. Please note that the sensor assembly 3 is specifically configured into a spherical shape and therefore its rotational angle is not limited to that of the pivots and levers as in the prior arts. In addition, as no levers or pivots are used, the sensor assembly 3 could have a smaller dimension and could be more flexibly applied to various lighting devices.

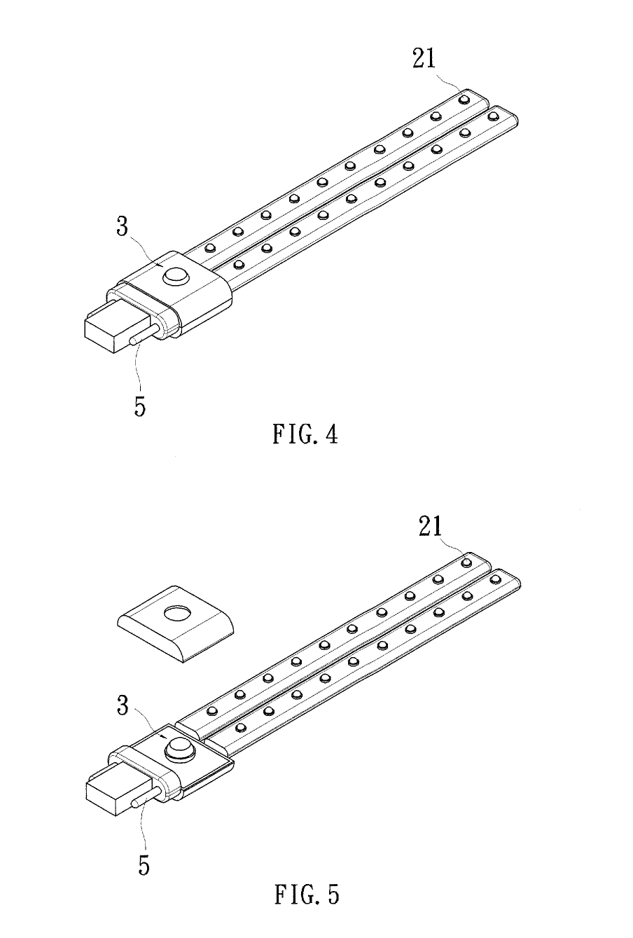

FIGS. 4 and 5 provide another embodiment of the present invention. As illustrated, there are two circuit boards 2 (along with their respective upper and lower casings) contained in the lighting device so as to achieve enhanced brightness from the additional. LEDs 21. The sensor assembly 3 is integrated with a power adaptor 5 where the sensor assembly 3 is further protected by a cover (not numbered). The sensor assembly is able to turn on and off of the LEDs 21 of both circuit boards 2.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lighting device with sensor, comprising:
an upper casing;
a lower casing;
a circuit board housed in a space formed by joining said upper and lower casings, said circuit board having at least a light emitting diodes;
two power adaptors where two ends of said upper casing, lower casing, and said circuit board are embedded, respectively; and
a sensor assembly having a cylindrical casing threaded in a ring, thereby jointly constituting a substantially spherical shape, said sensor assembly rotatably housed in a spherical concave adjacent to said light emitting diodes.

2. The lighting device according to claim 1, wherein said power adaptors is compatible with conventional sockets for fluorescent light tubes.
